(19) United States
(12) Patent Application Publication
(10) Pub. No.: US 2021/0117812 A1
(43) Pub. Date: Apr. 22, 2021

(54) COGNITIVE MODEL MODIFICATION

(71) Applicant: International Business Machines Corporation, Armonk, NY (US)

(72) Inventors: Mario J. Lorenzo, Miami, FL (US); Rebecca Lynn Dahlman, Rochester, MN (US); Jennifer Lynn La Rocca, Cary, NC (US); Debra L. Angst, Rochester, MN (US); Kristin E. McNeil, Charlotte, NC (US)

(21) Appl. No.: 16/659,721

(22) Filed: Oct. 22, 2019

(51) Int. Cl. G06N 5/02; G06K 9/00; G06K 9/62; G06F 17/28

(52) U.S. Cl. CPC G06N 5/022; G06F 17/2845; G06K 9/6228; G06K 9/00442

(57) ABSTRACT

Methods, systems, and computer program products for cognitive model modification are provided. Aspects include receiving a plurality of documents, receiving a cognitive model, identifying a set of cognitive model modification based on an alteration to the cognitive model, and for each cognitive model modification in the set of cognitive model modifications determining an updated concept or surface form based on each cognitive model modification, identifying one or more documents from the plurality of documents based on the updated concept or surface form, adding the one or more documents to a subset of documents, and generating an updated cognitive model based on one or more text analytics performed, by the cognitive model, on the subset of documents.

### BACKGROUND

The present invention generally relates to cognitive models, and more specifically, to natural language processing model modification using a cognitive analysis of a corpus.

Natural language processing (NLP) is a field of computer science, artificial intelligence, and linguistics concerned with the interactions between computers and human (natural) languages. As such, NLP is related to the area of human-computer interaction, and especially with regard to natural language understanding that enables computers to derive meaning from human or natural language input.

Many NLP systems make use of ontologies to assist in performing NLP tasks. An ontology is a representation of knowledge. A semantic ontology, in the case of NLP, is a representation of knowledge of the relationships between semantic concepts. Created by humans, usually by domain experts, ontologies are never a perfect representation of all available knowledge. Often they are very biased to a particular subarea of a given domain, and often reflect the level of knowledge or attention to detail of the author. Ontologies are usually task inspired, i.e. they have some utility in terms of managing information or managing physical entities and their design reflects the task for which their terminology is required. Generally speaking, the tasks hitherto targeted have not been focused on the needs of applications for cognitive computing or natural language processing and understanding.

Ontologies are often represented or modeled in hierarchical structures in which portions of knowledge may also be represented as nodes in a graph and relationships between these portions of knowledge can be represented as edges between the nodes. Examples of structures such as taxonomies and trees are limited variations, but generally speaking, ontology structures are highly conducive to being represented as a graph.

Examples of such semantic ontologies include the Unified Medical Language System (UMLS) semantic network for the medical domain, RXNORM for the drug domain, Foundational Model of Anatomy (FMA) for the human anatomy domain, and the like. The UMLS data asset, for example, consists of a large lexicon (millions) of instance surface forms in conjunction with an ontology of concepts and inter-concept relationships in the medical domain.

### SUMMARY

Embodiments of the present invention are directed to a computer-implemented method for natural language processing model modification. A non-limiting example of the computer-implemented method includes receiving a plurality of documents, receiving a cognitive model, identifying a set of cognitive model modification based on an alteration to the cognitive model, and for each cognitive model modification in the set of cognitive model modifications determining an updated concept or surface form based on each cognitive model modification, identifying one or more documents from the plurality of documents based on the updated concept or surface form, adding the one or more documents to a subset of documents, and generating an updated cognitive model based on one or more text analytics performed, by the cognitive model, on the subset of documents.

Embodiments of the present invention are directed to a system for natural language processing model modification. A non-limiting example of the system includes a processor configured to perform receiving a plurality of documents, receiving a cognitive model, identifying a set of cognitive model modification based on an alteration to the cognitive model, and for each cognitive model modification in the set of cognitive model modifications determining an updated concept or surface form based on each cognitive model modification, identifying one or more documents from the plurality of documents based on the updated concept or surface form, adding the one or more documents to a subset of documents, and generating an updated cognitive model based on one or more text analytics performed, by the cognitive model, on the subset of documents.

Embodiments of the invention are directed to a computer program product for natural language processing model modification, the computer program product comprising a computer readable storage medium having program instructions embodied therewith. The program instructions are executable by a processor to cause the processor to perform a method. A non-limiting example of the method includes receiving a plurality of documents, receiving a cognitive model, identifying a set of cognitive model modification based on an alteration to the cognitive model, and for each cognitive model modification in the set of cognitive model modifications determining an updated concept or surface form based on each cognitive model modification, identifying one or more documents from the plurality of documents based on the updated concept or surface form, adding the one or more documents to a subset of documents, and generating an updated cognitive model based on one or more text analytics performed, by the cognitive model, on the subset of documents.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a cloud computing environment according to one or more embodiments of the present invention;

FIG. 2 depicts abstraction model layers according to one or more embodiments of the present invention;

FIG. 3 depicts a block diagram of a computer system for use in implementing one or more embodiments of the present invention;

FIG. 4 depicts a block diagram of a system for cognitive model modification according to one or more embodiments of the invention;

FIG. 5 depicts a flow diagram of a method for cognitive model modification using a cognitive analysis of a corpus according to one or more embodiments of the invention; and

FIG. 6 depicts a flow diagram of a method for cognitive model modification according to one or more embodiments of the invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describe having a communications path between two elements and do not imply a direct connection between the elements with no intervening elements/connections between them. All of these variations are considered a part of the specification.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is a service oriented with a focus on statelessness, low coupling, modularity, and semantic interoperability. At the heart of cloud computing is an infrastructure that includes a network of interconnected nodes.

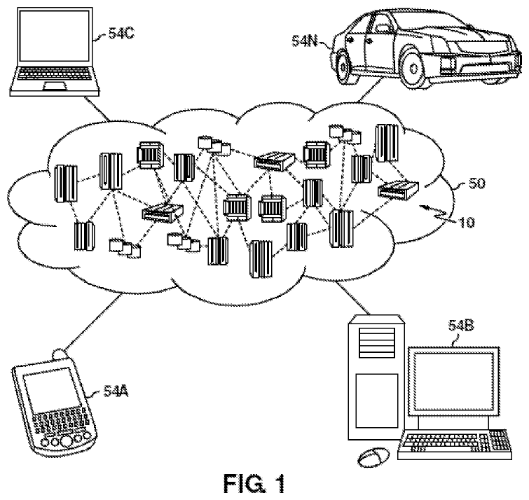

Referring now to FIG. 1, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

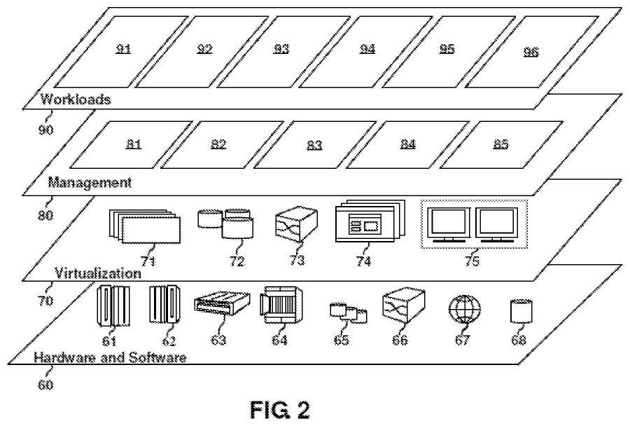

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and cognitive model modification using a cognitive analysis of a corpus 96.

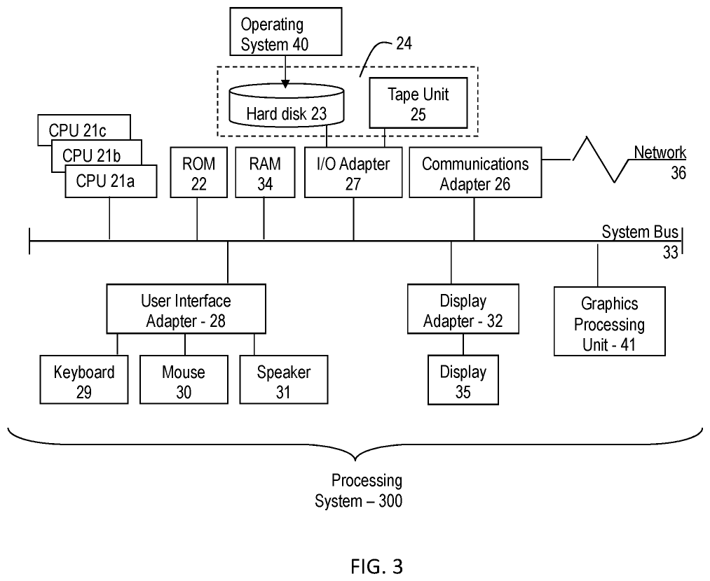

Referring to FIG. 3, there is shown an embodiment of a processing system 300 for implementing the teachings herein. In this embodiment, the system 300 has one or more central processing units (processors) 21a, 21b, 21c, etc. (collectively or generically referred to as processor(s) 21). In one or more embodiments, each processor 21 may include a reduced instruction set computer (RISC) microprocessor. Processors 21 are coupled to system memory 34 and various other components via a system bus 33. Read only memory (ROM) 22 is coupled to the system bus 33 and may include a basic input/output system (BIOS), which controls certain basic functions of system 300.

FIG. 3 further depicts an input/output (I/O) adapter 27 and a network adapter 26 coupled to the system bus 33. I/O adapter 27 may be a small computer system interface (SCSI) adapter that communicates with a hard disk 23 and/or tape storage drive 25 or any other similar component. I/O adapter 27, hard disk 23, and tape storage device 25 are collectively referred to herein as mass storage 24. Operating system 40 for execution on the processing system 300 may be stored in mass storage 24. A network adapter 26 interconnects bus 33 with an outside network 36 enabling data processing system 300 to communicate with other such systems. A screen (e.g., a display monitor) 35 is connected to system bus 33 by display adaptor 32, which may include a graphics adapter to improve the performance of graphics intensive applications and a video controller. In one embodiment, adapters 27, 26, and 32 may be connected to one or more I/O busses that are connected to system bus 33 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 33 via user interface adapter 28 and display adapter 32. A keyboard 29, mouse 30, and speaker 31 all interconnected to bus 33 via user interface adapter 28, which may include, for example, a Super I/O chip integrating multiple device adapters into a single integrated circuit.

In exemplary embodiments, the processing system 300 includes a graphics processing unit 41. Graphics processing unit 41 is a specialized electronic circuit designed to manipulate and alter memory to accelerate the creation of images in a frame buffer intended for output to a display. In general, graphics processing unit 41 is very efficient at manipulating computer graphics and image processing and has a highly parallel structure that makes it more effective than general-purpose CPUs for algorithms where processing of large blocks of data is done in parallel.

Thus, as configured in FIG. 3, the system 300 includes processing capability in the form of processors 21, storage capability including system memory 34 and mass storage 24, input means such as keyboard 29 and mouse 30, and output capability including speaker 31 and display 35. In one embodiment, a portion of system memory 34 and mass storage 24 collectively store an operating system that coordinates the functions of the various components shown in FIG. 3.

Turning now to an overview of technologies that are more specifically relevant to aspects of the invention, when building a natural language processing (NLP) model, a customer, usually, is not fully aware of the text within a corpus which results in various versions of the NLP model. When an NLP model is updated or modified, a customer's corpus of data would need to be re-analyzed by this new NLP model. This re-analysis can take considerable time as the customer's corpus can be relatively large taking days and weeks to process. A need exists that allows an NLP model to incrementally annotate documents based on a changing NLP model to save time for re-analysis of a corpus.

Turning now to an overview of the aspects of the invention, one or more embodiments of the invention address the above-described shortcomings of the prior art by providing a methodology for incrementally annotating documents based on changes to an NLP model. The methodology utilizes provenience of an annotation to figure out a smart ingestion to process only modifications in the NLP model and any dependent items. For example, if a new attribute is added to the NLP model, the re-analysis of the documents is run with only the new attribute. Also, for example, if an existing piece of the NLP model is edited or modified, the engine identifies the piece of the NLP model that was edited or modified, identifies the dependencies and reanalyzed this piece.

For an existing NLP model, when changes are made, a cognitive engine adds these changes to a record in order to track the modifications and additions. If a concept or surface form is deleted or renamed, both the prior concept or surface form and the new concept or surface form is stored. In addition, metadata associated with this deletion or rename is stored and linked to the document (e.g., document ID, document name, document time stamp, etc.). When a re-analysis is initiated, the cognitive engine will pull the list of modifications to the NLP model. The NLP model will evaluate the document's modification and create a search term list. For example, the search term list can include identification of a concept or synonym that has changed. This can be iteratively evaluated for each modification. The corpus of documents are then searched based on the identified search terms in the search term list. Any documents having the search terms in the search term list can be identified and added to a subset list of documents. The re-analysis is then run on the subset list of documents using the modified NLP model.

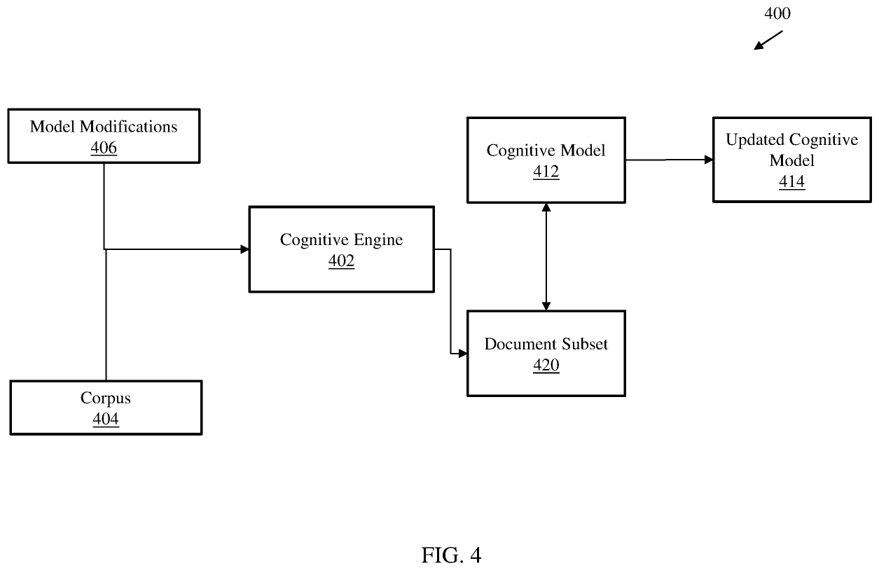

Turning now to a more detailed description of aspects of the present invention, FIG. 4 depicts a system for cognitive model modification according to one or more embodiments of the invention. The system 400 includes a cognitive engine 402 along with a corpus 404. The corpus 404 includes documents made up of structured and unstructured text. For example, in the medical field, the corpus can include medical records, medication literature, insurance records, and the like. The system 400 further includes an input of model modifications 406 and a cognitive model 412. In one or more embodiments, the cognitive engine 402 is utilized to compare the model modifications 406 inputted to determine a document subset 420. The document subset includes one or more documents that are utilized to update the cognitive model 412 based on the model modifications 406. The model modifications 406, as described briefly above, can include changes to the cognitive model 412 that include concepts and surface forms that can be added, removed, and/or updated/changed. Continuing with the medical field example, every year a new medication list is created that updates medical professionals with new medications that have come on the market. In addition, some medications are removed or changed. A customer with a cognitive model would need to update the model based on this new set of medications which include a variety of concepts and surface forms to be added to the model. Typically, the customer would update the model by re-running the model against the entire corpus. In one or more embodiments, the cognitive engine 402 identifies a document subset 420 from the corpus 404 that includes the concepts and surface forms from the model modifications 406 input. The cognitive model 412 is updated utilizing only the document subset 420 to create the updated cognitive model 414.

In one or more embodiments of the invention, the model modifications 406 include changes, additions, and deletions of concepts and surface forms. For changes, the cognitive engine 402 will utilize both the original concept or surface form and the change to the concept or surface form when analyzing the corpus to select the subset of documents. Similarly, for deletions, the cognitive engine 402 will include the concept or surface form before deletion to analyze the corpus and select affected documents that would later be utilized in the subset of documents.

In one or more embodiments of the invention, the cognitive model 412 can be a natural language processing (NLP) model.

In one or more embodiments of the invention, the cognitive engine 402 can be implemented on the processing system 300 found in FIG. 3. Additionally, the cloud computing system 50 can be in wired or wireless electronic communication with one or all of the elements of the system 400. Cloud 50 can supplement, support or replace some or all of the functionality of the elements of the system 400. Additionally, some or all of the functionality of the elements of system 400 can be implemented as a node 10 (shown in FIGS. 1 and 2) of cloud 50. Cloud computing node 10 is only one example of a suitable cloud computing node and is not intended to suggest any limitation as to the scope of use or functionality of embodiments of the invention described herein.

In embodiments of the invention, the engines 402 can also be implemented as so-called classifiers (described in more detail below). In one or more embodiments of the invention, the features of the various engines/classifiers (402) described herein can be implemented on the processing system 300 shown in FIG. 3, or can be implemented on a neural network (not shown). In embodiments of the invention, the features of the engines/classifiers 402 can be implemented by configuring and arranging the processing system 300 to execute machine learning (ML) algorithms. In general, ML algorithms, in effect, extract features from received data (e.g., inputs to the engines 402) in order to “classify” the received data. Examples of suitable classifiers include but are not limited to neural networks (described in greater detail below), support vector machines (SVMs), logistic regression, decision trees, hidden Markov Models (HMMs), etc. The end result of the classifier's operations, i.e., the “classification,” is to predict a class for the data. The ML algorithms apply machine learning techniques to the received data in order to, over time, create/train/update a unique “model.” The learning or training performed by the engines/classifiers 402 can be supervised, unsupervised, or a hybrid that includes aspects of supervised and unsupervised learning. Supervised learning is when training data is already available and classified/labeled. Unsupervised learning is when training data is not classified/labeled so must be developed through iterations of the classifier. Unsupervised learning can utilize additional learning/training methods including, for example, clustering, anomaly detection, neural networks, deep learning, and the like.

In embodiments of the invention where the engines/classifiers 402 are implemented as neural networks, a resistive switching device (RSD) can be used as a connection (synapse) between a pre-neuron and a post-neuron, thus representing the connection weight in the form of device resistance. Neuromorphic systems are interconnected processor elements that act as simulated “neurons” and exchange “messages” between each other in the form of electronic signals. Similar to the so-called “plasticity” of synaptic neurotransmitter connections that carry messages between biological neurons, the connections in neuromorphic systems such as neural networks carry electronic messages between simulated neurons, which are provided with numeric weights that correspond to the strength or weakness of a given connection. The weights can be adjusted and tuned based on experience, making neuromorphic systems adaptive to inputs and capable of learning. For example, a neuromorphic/neural network for handwriting recognition is defined by a set of input neurons, which can be activated by the pixels of an input image. After being weighted and transformed by a function determined by the network's designer, the activations of these input neurons are then passed to other downstream neurons, which are often referred to as “hidden” neurons. This process is repeated until an output neuron is activated. Thus, the activated output neuron determines (or “learns”) which character was read. Multiple pre-neurons and post-neurons can be connected through an array of RSD, which naturally expresses a fully-connected neural network. In the descriptions here, any functionality ascribed to the system 400 can be implemented using the processing system 300 applies.

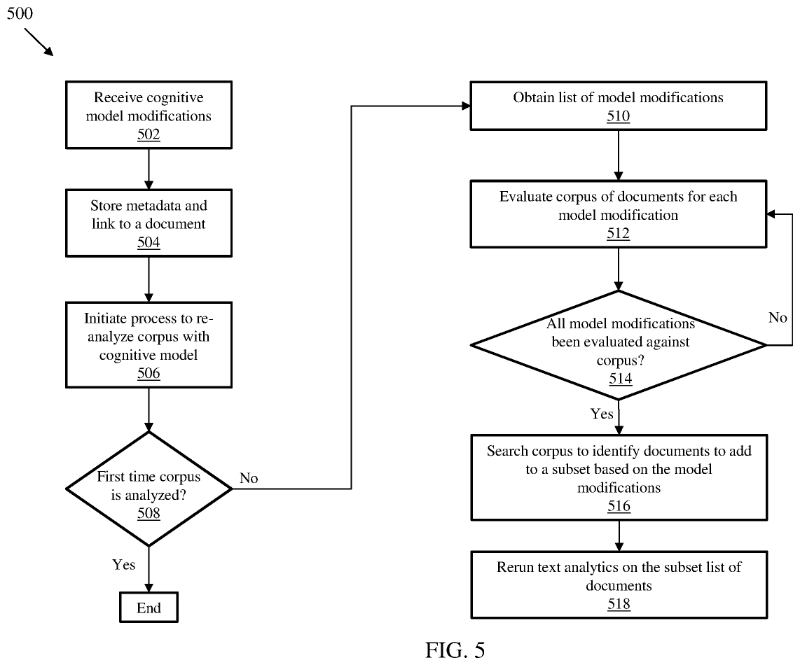

FIG. 5 depicts a flow diagram of a method for cognitive model modification using a cognitive analysis of a corpus according to one or more embodiments of the invention. The method 500 includes receiving cognitive model modifications, as shown in block 502. As described briefly above, changes to the cognitive model include updates, changes, and deletions of concepts and surface forms and can be customer and industry specific. As customer needs change, the model updates are needed so that the cognitive models can better serve the customer requirements. These updates can be based on changes in the industry or changes in customer business focus. For example, changes in acronyms or jargon used in the industry can spark the need to update a model. As shown in block 504, the method 500 includes storing metadata and linking the metadata to a document from the corpus. At block 506, the method 500 includes initiated a process to re-analyze the corpus with the cognitive model. As mentioned above, the process to re-analyze can be triggered by a number of events such as changes in the customer industry or internal changes that require the update, addition, and/or removal of concepts and surface forms from the cognitive model. The method 500, at decision block 508, determines if this is the first time the cognitive model is being run against the corpus. If this is the first time (i.e., “yes”), the method 500 ends as this described method 500 is for updated a cognitive model and not for an initial run against an entire corpus. If this is not the first time (i.e., “no”), the method 500 proceeds to block 510 wherein the method 500 obtains a list of model modifications for updating the cognitive model. Then, the method 500, at block 512, evaluates the corpus for each model modification and tags documents within the corpus as being affected by the modification of the model. This process is performed iteratively for each model modification as shown in decision block 514 wherein the decision as to whether all the modifications have been evaluated against the corpus. If “no,” then the method 500 goes back to block 512 and continues iteratively until all modifications have been evaluated. Thus, when all modifications have been evaluated (i.e., “yes”), then the method 500 proceeds to block 516 where a subset of documents are identified based on the model modifications. And at block 518, the method 500 re-runs text analytics on the subset list of documents to update the cognitive model. Re-running the cognitive model against a subset of documents instead of the entire corpus saves time and processing resources during updates to the model.

Additional processes may also be included. It should be understood that the processes depicted in FIG. 5 represent illustrations, and that other processes may be added or existing processes may be removed, modified, or rearranged without departing from the scope and spirit of the present invention.

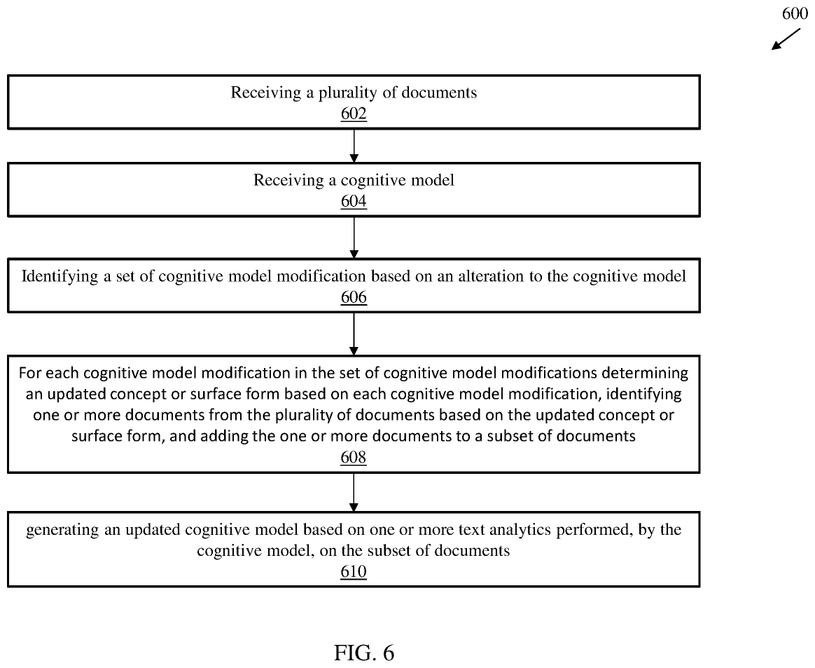

FIG. 6 depicts a flow diagram of a method for cognitive model modification according to one or more embodiments of the invention. The method 600 includes receiving a plurality of documents, as shown in block 602. At block 604, the method 600 includes receiving a cognitive model. The method 600, at block 606, includes identifying a set of cognitive model modification based on an alteration to the cognitive model. Also, the method 600 includes for each cognitive model modification in the set of cognitive model modifications determining an updated concept or surface form based on each cognitive model modification, identifying one or more documents from the plurality of documents based on the updated concept or surface form, and adding the one or more documents to a subset of documents, as shown in block 608. And at block 610, the method 600 includes generating an updated cognitive model based on one or more text analytics performed, by the cognitive model, on the subset of documents.

Additional processes may also be included. It should be understood that the processes depicted in FIG. 6 represent illustrations, and that other processes may be added or existing processes may be removed, modified, or rearranged without departing from the scope and spirit of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A method for cognitive model modification analysis, the method comprising:
receiving a plurality of documents;
receiving a cognitive model;
identifying a set of cognitive model modification based on an alteration to the cognitive model;
for each cognitive model modification in the set of cognitive model modifications:
determining an updated concept or surface form based on each cognitive model modification;
identifying one or more documents from the plurality of documents based on the updated concept or surface form; and
adding the one or more documents to a subset of documents; and
generating an updated cognitive model based on one or more text analytics performed, by the cognitive model, on the subset of documents.

2. The method of claim 1, wherein the updated concept or surface form comprises a deletion of a concept or surface form from the cognitive model.

3. The method of claim 1, wherein the updated concept or surface form comprises an addition of a concept or surface form from the cognitive model.

4. The method of claim 1, wherein the identifying one or more documents based on the updated concept or surface form comprises searching the plurality of documents to identify one or more documents containing the updated concept or surface form.

5. The method of claim 1, wherein the cognitive model comprising an natural language processing (NLP) model.

6. The method of claim 1, wherein the plurality of documents comprise a medical corpus.

7. The method of claim 1, wherein the plurality of documents comprise unstructured text.

8. A system for cognitive model modification comprising:
a processor communicatively coupled to a memory, the processor configured to:
receive a plurality of documents;
receive a cognitive model;
determine an alteration to the cognitive model;
identify a set of cognitive model modification based on the alteration to the cognitive model;
for each cognitive model modification in the set of cognitive model modifications:
determine an updated concept or surface form based on each cognitive model modification;
identify one or more documents from the plurality of documents based on the updated concept or surface form; and
add the one or more documents to a subset of documents; and
generate an updated cognitive model based on one or more text analytics performed, by the cognitive model, on the subset of documents.

9. The system of claim 8, wherein the updated concept or surface form comprises a deletion of a concept or surface form from the cognitive model.

10. The system of claim 8, wherein the updated concept or surface form comprises an addition of a concept or surface form from the cognitive model.

11. The system of claim 8, wherein the identifying one or more documents based on the updated concept or surface form comprises searching the plurality of documents to identify one or more documents containing the updated concept or surface form.

12. The system of claim 8, wherein the cognitive model comprising an natural language processing (NLP) model.

13. The system of claim 8, wherein the plurality of documents comprise a medical corpus.

14. The system of claim 8, wherein the plurality of documents comprise unstructured text.

15. A computer program product for cognitive model modification comprising a computer readable storage medium having program instructions embodied therewith, the program instructions executable by a processor to cause the processor to perform a method comprising:
receiving a plurality of documents;
receiving a cognitive model;
determining an alteration to the cognitive model;
identifying a set of cognitive model modification based on the alteration to the cognitive model;
for each cognitive model modification in the set of cognitive model modifications:
determining an updated concept or surface form based on each cognitive model modification;
identifying one or more documents from the plurality of documents based on the updated concept or surface form; and
adding the one or more documents to a subset of documents; and
generating an updated cognitive model based on one or more text analytics performed, by the cognitive model, on the subset of documents.

16. The computer program product of claim 15, wherein the updated concept or surface form comprises a deletion of a concept or surface form from the cognitive model.

17. The computer program product of claim 15, wherein the updated concept or surface form comprises an addition of a concept or surface form from the cognitive model.

18. The computer program product of claim 15, wherein the identifying one or more documents based on the updated concept or surface form comprises searching the plurality of documents to identify one or more documents containing the updated concept or surface form.

19. The computer program product of claim 15, wherein the cognitive model comprising an natural language processing (NLP) model.

20. The computer program product of claim 15, wherein the plurality of documents comprise a medical corpus.
